(19) United States
(12) Patent Application Publication
(10) Pub. No.: US 2008/0243577 A1
(43) Pub. Date: Oct. 2, 2008

(54) APPARATUS AND METHOD FOR PROCESSOR DRIVEN CONCEPT AUCTION

(76) Inventors: Steven Schwartz, Saline, MI (US); Lorenz Schmitt, Ann Arbor, MI (US); Robert J. Jericho, Glenview, IL (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 12/048,617

(22) Filed: Mar. 14, 2008

Related U.S. Application Data
(60) Provisional application No. 60/894,820, filed on Mar. 14, 2007.

(51) Int. Cl. G06Q 10/00

(52) U.S. Cl. 705/8; 705/7

(57) ABSTRACT

A method for executing a concept auction is provided that includes inputting information for one or more concepts; storing the concepts in a memory device; assigning a number of shares to each concept; assigning a bidding unit to each participant bidding on a selected concept; and determining the results of the auction based on bid information provided by each participant.

### CROSS-REFERENCE TO RELATED APPLICATIONS

The present application is a conversion to a non-provisional from U.S. Provisional application Ser. No. 60/894,820 filed on Mar. 14, 2007 and claims priority to that application.

### BACKGROUND

The present invention relates to computer processing tools used to assist organizations, for example corporations, in making decisions amongst multiple options.

Organizations, such as corporations are frequently presented with opportunities to pursue multiple strategies and/or opportunities. These opportunities may range from exploring new markets, new products, allocation of corporate resources to pursue research and development to choosing what vendors to select, deciding what corporate developments are appropriate for patent coverage and the like. Frequently companies will make such decisions by gathering corporate decision makers into a room and discussing the pros and cons of any given choice. The corporate decision makers utilize a myriad of tools to make choices ranging from simple votes to putting post-it notes on the wall. Other times decisions may be made exclusively by the gut feel of a leader of any given organization. Decisions made from such meetings may suffer from a lack of participation or restraint on behalf of younger or less senior representatives. In any of these situations the richness in knowledge of the organization is untapped.

Therefore, a need has arisen to provide a process driven decision making tool that allows for a broader depth of the organizations knowledge to be tapped.

### BRIEF DESCRIPTION OF THE DRAWINGS

FIG. 1 is schematic representation of a computer processor device configured through feed inputs reflecting concepts and bid information and to automatically execute an auction of those concepts and tabulate the results;

FIGS. 2A and 2B are process flow charts illustrating an exemplary concept auction;

FIG. 3 is an exemplary analyst report template describing concepts to be bid;

FIG. 4 is another exemplary analyst report template describing concepts to be bid;

FIG. 5 illustrates an exemplary first price sealed bid auction;

FIG. 6 illustrates the results of a first price sealed bid auction;

FIGS. 7-10 illustrate exemplary auction result outputs;

FIG. 11 illustrates an exemplary process for executing a concept auction according to an embodiment; and

FIG. 12 illustrates an exemplary clearing process for executing a concept auction according to an embodiment.

### DETAILED DESCRIPTION

When multiple ideas are under consideration by an organization, such as a corporation, it is often difficult to evaluate and assess the ideas relative to making a choice amongst them. Therefore, an apparatus and method for creating a concept auction of the ideas is provided. The auction results may reveal information not apparent to the organization that may be useful in guiding the organization in allocating its time and resources and to evaluate and track alternatives. The concept auction can be used to determine the relative value of ideas, technology, opportunities, products, experiences or any other entity where one is trying to determine the relative value of a number of future possibilities. The market dynamic of an auction provides insight into the depth and breadth of support for a particular concept; the distributions of priorities; the confidence in rankings and determines whether closely ranked ideas are truly close alternatives. In addition, the auction results determine where the ideas and concepts “cluster.” And finally, the auction results can help to determine who the most astute “investors” may be (i.e., the people who are best at estimating the future value and anticipating organizational receptiveness). In the context of a corporation the auction results may reveal that a business opportunity previously thought to be highly desirable is not because consensus does not exist. Alternately, a business opportunity that sat on the fringes may be perceived as more desirable to the extent its share price is bid to a comparatively high value.

An apparatus for a process driven concept auction includes a data-based processor or computer is configured to receive inputs of concepts. In one embodiment, the concepts are stored in a memory device within the data-based processor. These concepts may include a wide variety of items ranging from high level decisions regarding the future of the organization, to low level decisions regarding short term allocation of resources. A common metric for information to be input for each of the concepts includes a brief description of the concept, which may include its history, existing technology/product relationships and any measurable facts regarding its costs and benefits. To implement the auction, each concept is assigned a number of hypothetical shares, just as a corporation may have shares of stock. A wide range of representatives from the organization (or other organizations) may then be invited to bid in an auction format for the shares of the concept.

In one embodiment, each decision maker is assigned a fixed amount of bidding units (e.g., fictional money) and asked to bid on shares of the available concepts. Each bid reflects a share price and a total number of shares requested. By controlling the amount of bidding units allocated to each bidder, and fixing the number of shares available for bid, meaningful information can be derived from the collective bidding process. The bid information is stored and an arithmetic processor within the data processor evaluates the bid packages submitted by each decision maker using one of many optional auction implementations. Two examples of possible auction implementations are a First-Price Sealed-Bid (FPSB) type auction or a uniform-price type (VICKERY) auction.

The arithmetic processor may organize the bid results in a variety of ways including, but not limited to, information on average share price for each concept; identification of the successful bidders; an overall range of bids and the amount of money made or lost by each bidder. Bid results may be informative of the depth and breadth of support for any given concept. The results may reveal whether consensus exists for any concept.

The embodiments herein will be described with reference to a corporate environment in which multiple business opportunities are being considered. In this environment the business opportunity represents the concept to be auctioned. The concept auction is equally applicable to any organization or group of people making a decision to allocate resources, regardless of whether those resources are time or money.

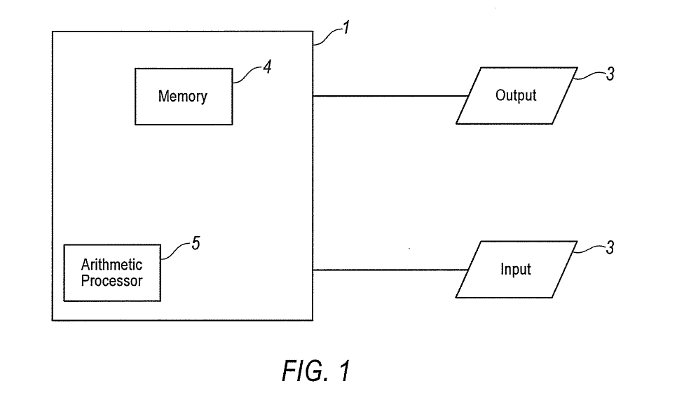

With reference to the Figures wherein like items are numbered alike and in particular with reference to FIG. 1 there is shown a schematic of an apparatus configured to execute a concept auction. The apparatus includes a data based processor or computer 1, which may include an input device 2 and an output device 3. The data based processor 1 includes memory 4, for example DRAM or a data disk. The processor includes an arithmetic logic circuit 5 configured to carry out the concept auction. The arithmetic logic circuit 5 is configured to retrieve data saved in the memory 4 and award shares in each concept based on bid price per share. The auction results are reported to any of a memory within the data based processor 1 or directly to the output 3. The concept auction may be carried out on a stand alone computer as shown in FIG. 1, or in the alternate may be carried in a web based environment where data is input by remote computers and the processing of the auction takes place at a remote server.

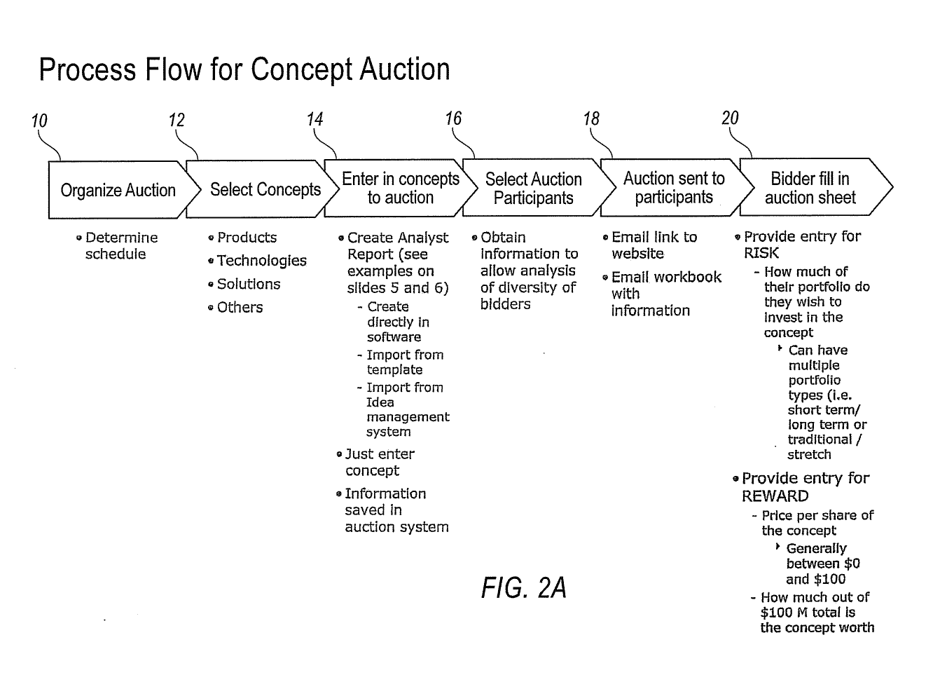

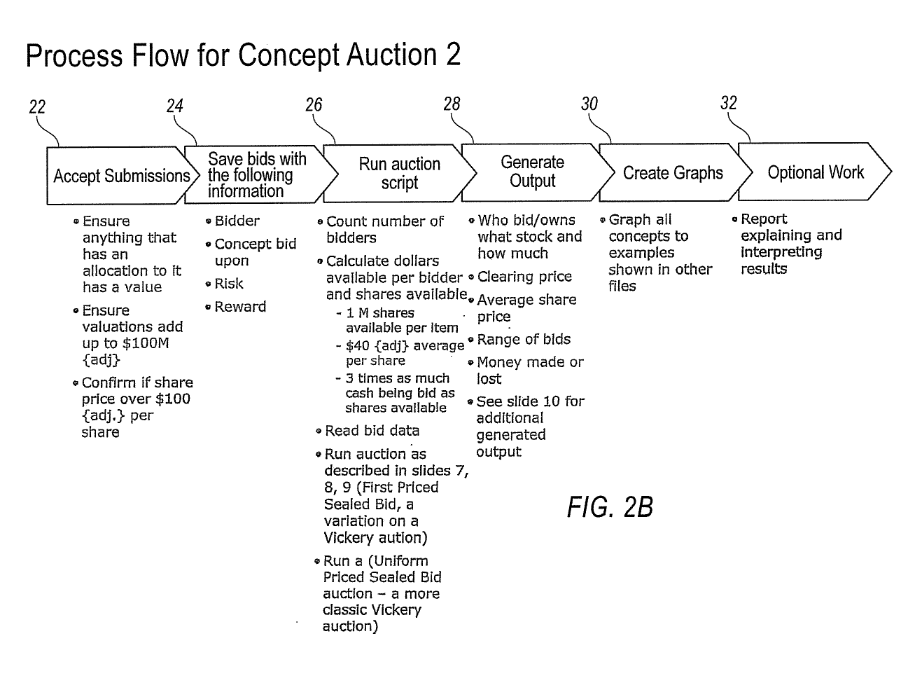

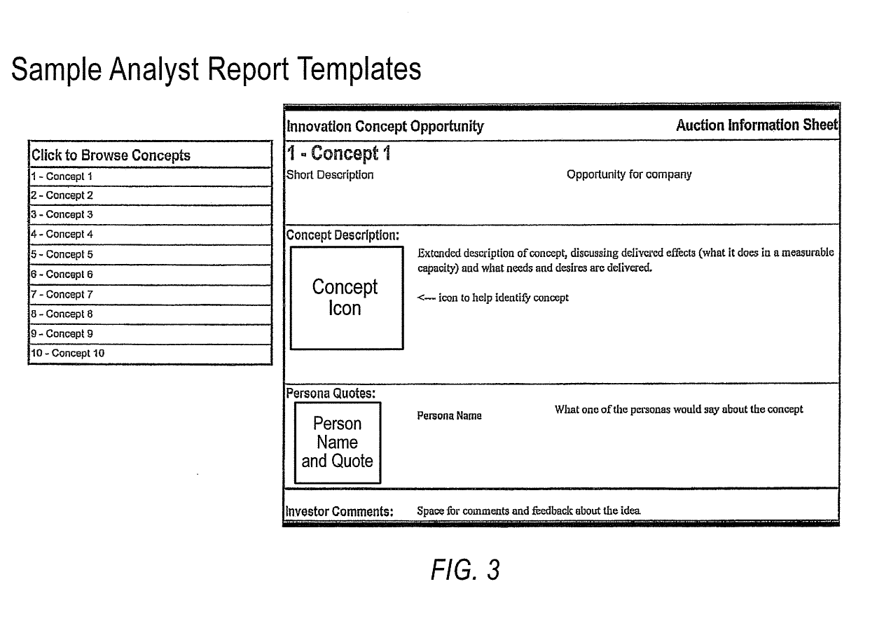

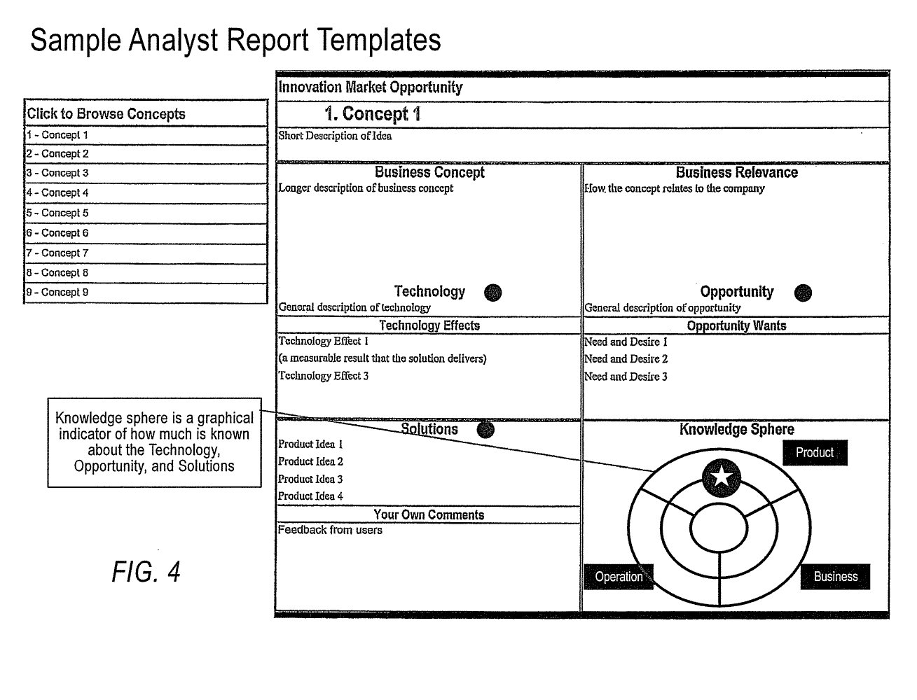

With reference to FIGS. 2A and 2B a flow chart of a process driven concept auction is shown. Steps 10, 12 and 14 illustrate a first aspect of the process driven concept wherein the auction is organized and concepts are selected and information describing each concept is input. In one embodiment, the concepts may be represented using a common analogical framework. Alternately, templates such as those shown in FIGS. 3 and 4, may be used to assist the process of organizing data for a concept. For example, in addition to a short description regarding the concept, different people within the organization may give a comment; a case can be made for the business relevance of the concept and/or the problems solved by the concept may be presented.

The concept information may be stored in memory 4 for later retrieval by bidders. Each bidder may review the data corresponding to stored concept and enter bids into the data processing device 1. As discussed in greater detail below, the bids may reflect a bid price and a number of desired shares. The bid information is stored in memory for later use by an arithmetic unit 5 within the processor 1 to execute an auction as described in greater detail below.

With reference to FIGS. 2A and 2B, step 16 illustrates that the concept organizers may be prompted to select appropriate participants for the auction. By selecting a diverse and independent range of participants, a deeper understanding of a corporate view may be developed. Within the data processing device the invited participants are allocated individual memory slots within processor device 1, so that the data processor 1 may later expect bid information from the selected participants.

The instant concept auction may take advantage of research into the phenomenon coined the “wisdom of crowds,” which relates to the power of a group of diverse and independent individuals to evaluate alternates. A large group of bidders differentiates from individual judgment and delivers an aggregate intelligence of the organization as a whole. For example, the knowledge possessed by managers and sales personnel in direct day to day contact with customers can be involved where it otherwise might not be. Even organization outsiders, such as customers, may be included in the process.

At step 18, the processor 1 forwards the auction information to the select participants. This may be done in a variety of ways, for example, via email or through a like to a website. Bidders may then bid for shares in each concept as shown below. At step 20, the second aspect of the auction is shown, which involves the bidder filling out an auction sheet or otherwise recording their selection to set their proposed bid for “shares” in the various concepts. For example, each concept may have one thousand shares and each bidder may be given one million bidding units to bid, which in this case, may be fictional dollars. By giving each bidder one million fictional dollars, the system weighs each bidder identically. In an alternate system, certain strategic bidders may be allocated more fictional dollars. This may be useful where a group is under-represented. Thus, if a corporation has half the representation in Europe as in America the system may give the European based bidders twice the fictional dollars as the American based bidders. The computer processor 1 could be configured to prompt each bidder as to whether they want to bid on any shares, and if so, how many shares and at what price. Each bidder may input their bid information into the data processor 1 where that bid information is stored in memory 4.

With reference to FIGS. 2A and 2B, bidders make their bid selections at step 22 and save them at step 24. With reference to the non-limiting example where each concept has allocated to it one thousand shares, and each bidder has one million fictional dollars, each bidder will make selections of the concepts the bidder desires to bid on, including the number of shares and the bid price for each share. Optionally, the processor may be configured to prompt a bidder to ensure that the total bids tally to the one million dollars available for bid. After all of the bid data has been received by the data processor, the arithmetic processor 5 determines the results of the auction based on the bid data in memory. The auction process may be of any of a variety of types. Two representative types, while not limiting, are a first-price sealed-bid (FPSB) type and a Second-Price Sealed-Bid (SPSB) type.

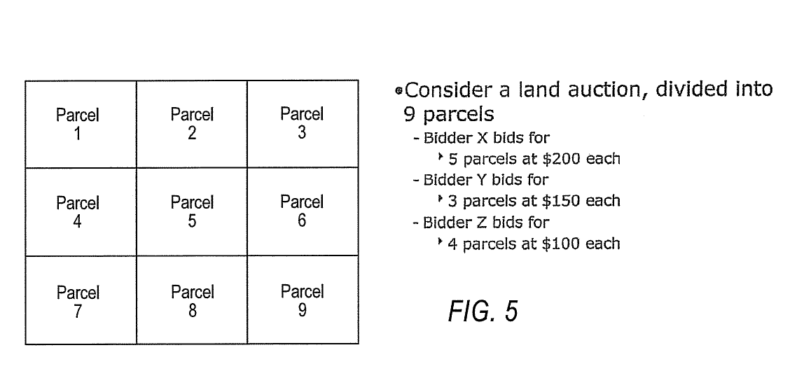

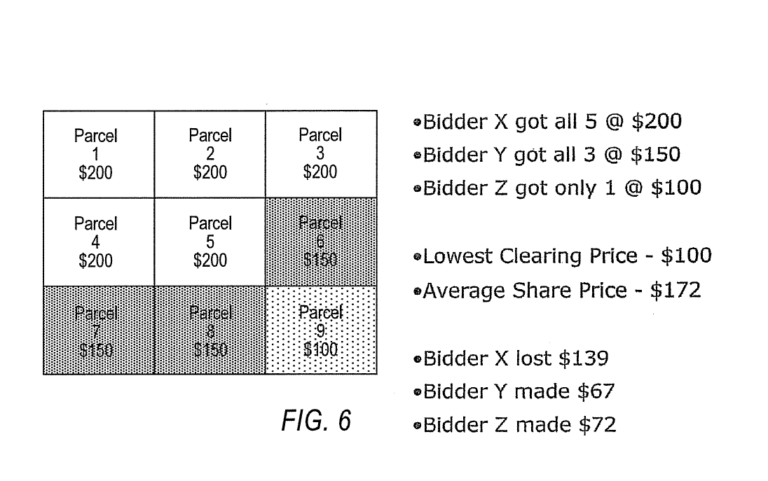

FIG. 5 illustrates an exemplary first-price sealed-bid auction type dealing with three bidders and nine parcels of property. Each bidder may bid a different amount. As shown bidder X bids for 5 parcels at two hundred dollars per parcel, bidder Y bids for three parcels at one hundred and fifty per parcel and bidder Z bids for four parcels at one hundred dollars per parcel. FIG. 6 illustrates the results of the first-price sealed-bid auction shown in FIG. 5, wherein bidder X obtained all five parcels and paid two hundred dollars per parcel, bidder Y obtained all three parcels and paid one hundred fifty for each. Bidder Z obtained only one parcel, and paid one hundred dollars for that parcel. Against an average parcel price of one hundred and seventy two dollars it can be seen that bidder X lost one hundred and thirty nine dollars, bidder Y made sixty seven dollars, and bidder Z made seventy two dollars.

In the next step of the process-driven auction, the auction data is evaluated and an auction process is run by the processor 1. A wide variety of auction types are available. In one embodiment the auction implemented by the processor 1 is a first-price sealed-bid auction. In a first-price sealed-bid auction the highest sealed bid for the shares of any given concept is allocated the bid for shares. A first-price sealed-bid auction style will indicate information reflective of whether the individual bidders overpaid for any given concept. Many other alternate auction bid types may be utilized. For example, a second price sealed bid or VICKREY auction style can be used wherein the winning bid for any given share for a concept is one increment lower than the lowest winning bid. Thus, for the example of FIGS. 5 and 6, bidder X would pay not more than ninety-nine dollars for the highest priced parcel.

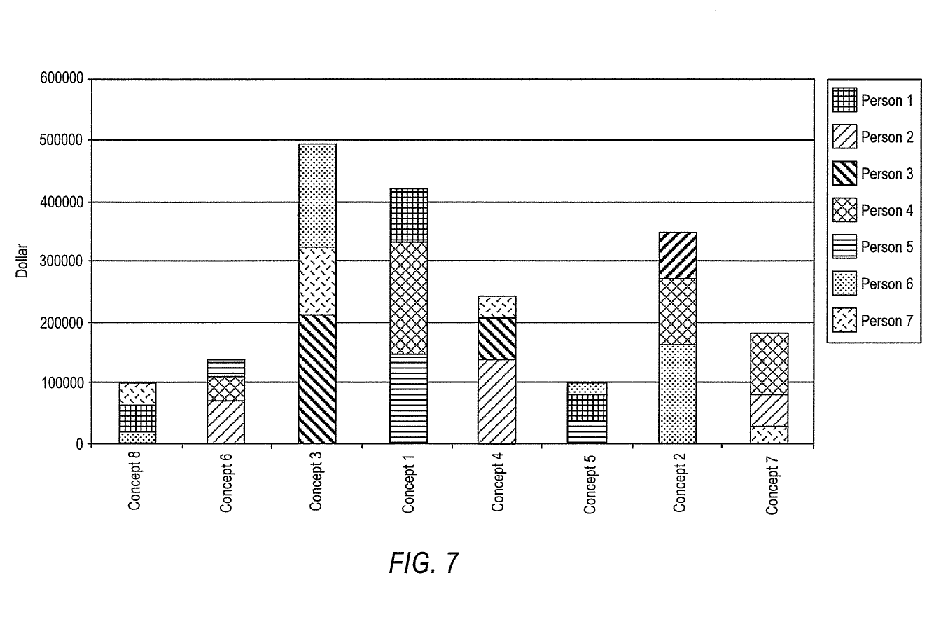

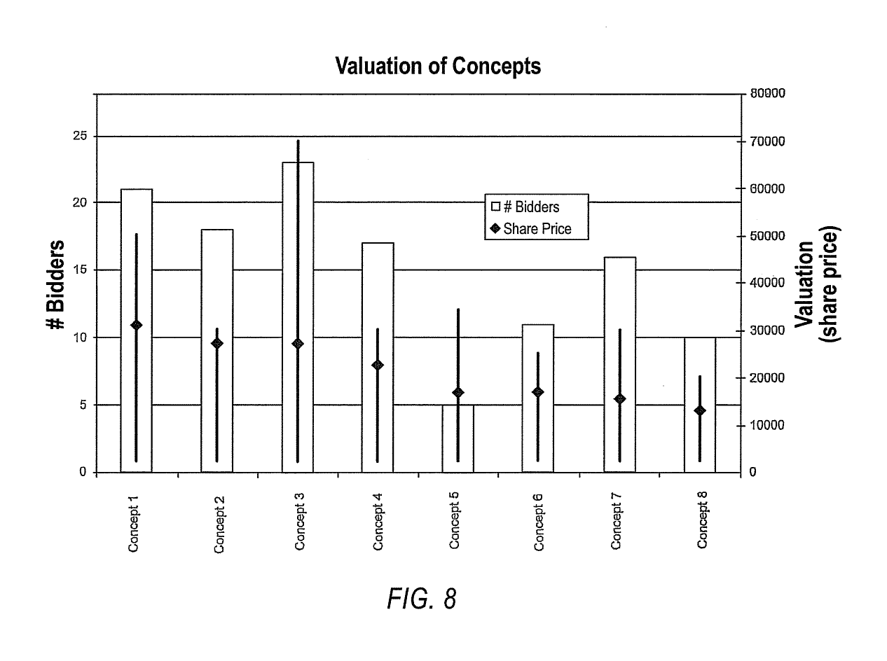

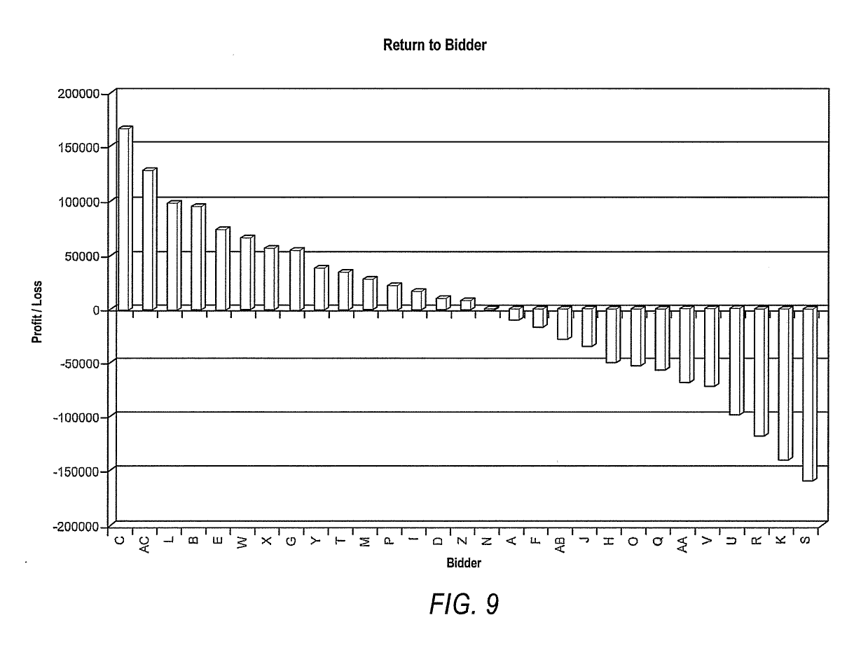

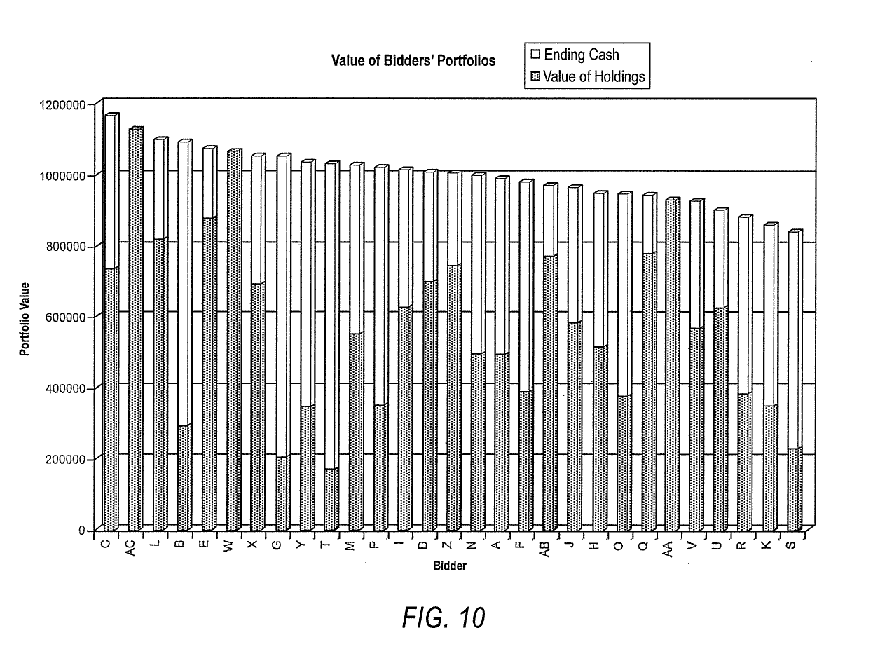

Returning to FIG. 2B, at step 28 the results of the auction are output. These results may be configured to indicate which individuals own how many shares in any given concept. The results may also be configured to reflect the clearing price for the concepts shares, the average price per share, the range of bids, and the money made or lost by any individual bidder. This data may be used to draw a number of conclusions relative to evaluating whether an organization or group of people should consider the concept further. For example, and with reference to FIGS. 7 through 10, the process may generate a variety of different outputs. These outputs may provide substantial insight into the organizations viewpoint relative to the concepts under consideration. The output may illustrate which concepts are the most valued, whether consensus exists with respect to the different concepts, and may be a useful aid in helping the organization going forward.

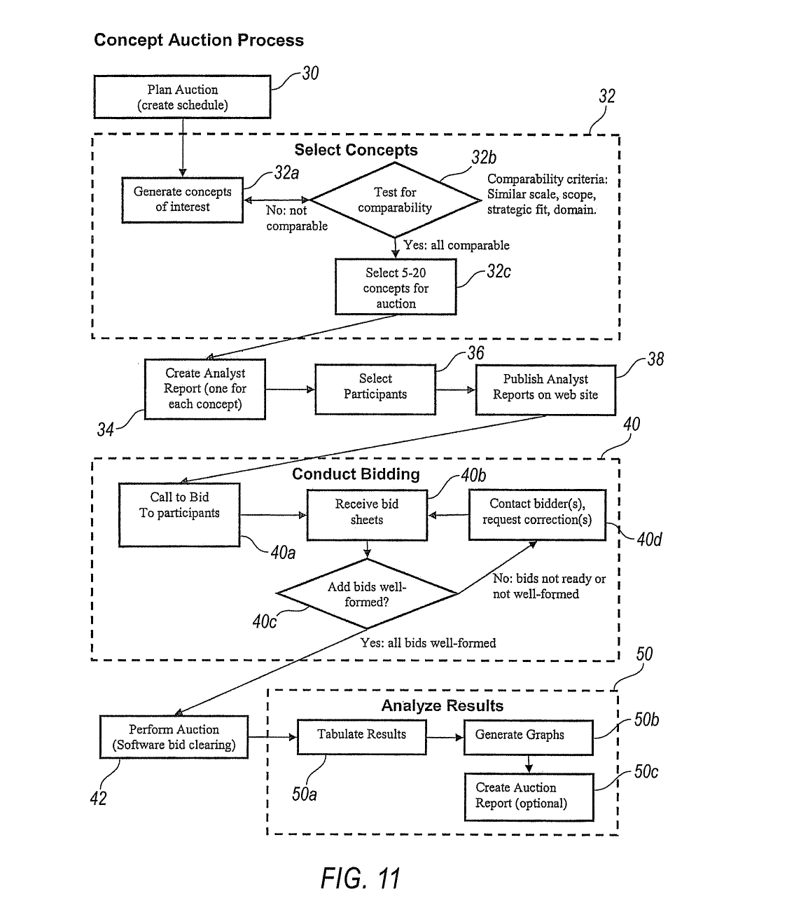

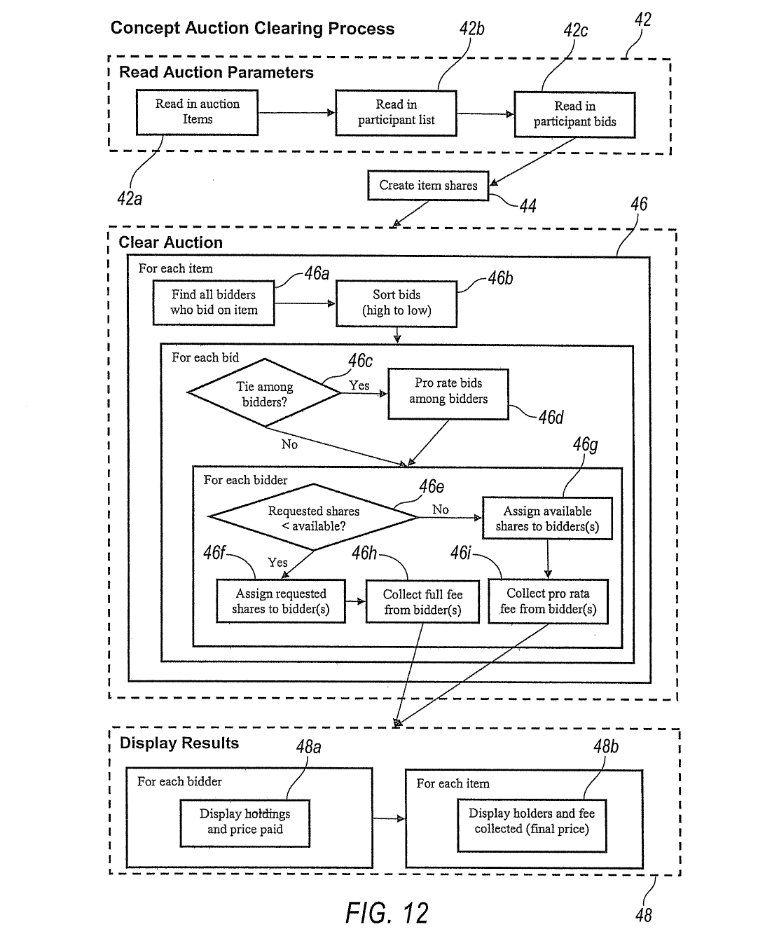

FIGS. 11 and 12 illustrate another exemplary process driven concept auction. In this example, the first steps 30 and 32 are to plan the auction by creating a schedule and selecting concepts. Selecting concepts includes generating concepts of interest (step 32a), then testing the concepts (step 32b) against comparability criteria that may include similar scale, scope, strategic fit and domain. At step 32c, a determined number (e.g., five to twenty) of concepts are selected for auction.

Next, at step 34 an analysis report is created for each concept. For example, the determined number of concepts selected above in step 32 can range in subject in their level of detail, focus and specificity. Likewise, they may fall under three primary areas of idea assessment, namely, technology, community and solution. One of the goals of this system is to develop these ideas into a descriptive and analytic framework to minimize information asymmetries among the bidding participants. This means translating and enhancing each raw idea into a concept analysis report, which provides a structured and consistent means of communicating an idea. The concept analysis report turns a raw idea into a formed concept allowing a reviewer to make their own, independent judgment of what is being proposed and what recommends it to a company portfolio. In general, the concept analysis report includes at least four sections, a description, technology effects, community wants and concept solutions. Descriptions usually consist of a one to two hundred word description of the concept emphasizing the essence of the idea and relevant information (e.g., history, existing technology, product relationships, etc.). Technology effects are possibilities of the technology expressed purely as measurable effects, while removing specific manifestations (e.g., removing the applications or possible product descriptions). Technology effects describe the essence of the technology and allow the reader to project possible extensions and other uses. Community wants specifically identify the needs and desires of a potential market answering the question of “what is this opportunity going to solve and for whom?” The opportunities addressed are based on the needs and desires of people who will potentially experience the technology in some form. And finally, solution concepts are specific ideas for potential product, services, operations, or business models. This includes ideas on how the technology would be applied or the opportunity exploited, was well as ideas on potential markets and competitive replacements.

Returning to FIG. 11, at step 36 the participants are selected and at step 38 the concept analysis reports are published to the website. The bidding process is then conducted at step 40 and includes a calling to bid participants (step 40a), receiving the bids (step 40b), and determining if all bids are well formed (e.g., have any errors) (40c). If corrections to the bids are required, the bidders are requested to make appropriate corrections at step 40d. If all bids are well formed at step 40c, the auction is performed at step 42 using an exemplary software bid clearing process, as shown in FIG. 12.

In one embodiment, the bid clearing process includes reading auction parameters at step 42, which includes reading in auction items (step 42a), reading in a participant list (step 42b), and reading in participants bids at step 42c. At step 44 item shares are created and at step 46, the auction is cleared. In this example, the auction is cleared for each item by searching at step 46a for all bidders who bid on a particular item. The bids are then sorted at step 46b from highest to lowest. It is understood that the sorting order is not limited from high to low and thus may vary according to other process auction methods and configurations.

For each bid it is determined whether there is a tie among bidders (step 46c), and if so, the tied bids are prorated among the bidders (step 46d). At step 46e, for each bidder it is determined if the requested bidder shares are less than what they have available. If the requested shares are available, they are assigned to the bidder at step 46f, if not, only the number of available shares are assigned (step 46g). In either event, the full fee (step 46h) or the prorated fee (step 46i) is collected from each bidder. At step 48, for each bidder the holdings and price paid are displayed (step 48a), and for each item, the holders and fee collected (i.e., final price) are displayed (step 48b).

Returning to FIG. 11, the results are analyzed at step 50 and generally include tabulating results (step 50a), generating graphs (step 50b) and creating an auction report (step 50c).

Computing devices such as those used for computer or processor 1, input and output devices 2 and 3, memory 4 or arithmetic processor 5 may employ any of a number of computer operating systems known to those skilled in the art, including, but by no means limited to, known versions and/or varieties of the Microsoft Windows® operating system, the Unix operating system (e.g., the Solaris® operating system distributed by Sun Microsystems of Menlo Park, Calif.), the AIX UNIX operating system distributed by International Business Machines of Armonk, N.Y., and the Linux operating system. Computing devices may include any one of a number of computing devices known to those skilled in the art, including, without limitation, a computer workstation, a desktop, notebook, laptop, or handheld computer, or some other computing device known to those skilled in the art.

Computing devices such as those listed above generally each include one or more memories for storing, and one or more processors for executing, instructions such as those included in a computer program such as the applications and concepts shown in FIGS. 2A and 2B. Various steps and processes disclosed herein may be embodied in whole or in part in such instructions. Computer-executable instructions may be compiled or interpreted from computer programs created using a variety of programming languages and/or technologies known to those skilled in the art, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of known computer-readable media.

A computer-readable medium includes any tangible medium that participates in providing data (e.g., instructions), which may be read by a computer. Such a medium may take many forms, including, but not limited to, non-volatile media and volatile media. Non-volatile media include, for example, optical or magnetic disks and other persistent memory. Volatile media include dynamic random access memory (DRAM), which typically constitutes a main memory. Such instructions may be transmitted by one or more transmission media, including coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Databases or data stores described herein may include various kinds of mechanisms for storing, accessing, and retrieving various kinds of data, including a hierarchical database, a set of files in a file system, an application database in a proprietary format, a relational database management system (RDBMS), etc. Each such database or data store is generally included within a computing device employing a computer operating system such as one of those mentioned above, and are accessed via a network in any one or more of a variety of manners, as is known. A file system may be accessible from a computer operating system, and may include files stored in various formats. An RDBMS generally employs the known Structured Query Language (SQL) in addition to a language for creating, storing, editing, and executing stored procedures, such as the PL/SQL language mentioned above.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their broadest reasonable constructions and their ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A data processing system for illustrating organizational information relating to a contemplated concept, comprising:
computer processor means for processing data;
storage means for storing data on a storage medium;
first means configured to receive information describing a concept to be evaluated by the computer processor means; each concept having an assigned number of shares; the concept information being stored in the storage means;
second means configured to receive bid information reflective of a bid price for a defined number of shares; the bid information being stored in the storage means;
third means configured to process the bid information in an auction format to determine the number of shares to be allocated to each bidder, and;
fourth means to report the results of the auction.

2. A data processing system as in claim 1 wherein the auction format is a VICKREY type auction.

3. A data processing system as in claim 2 wherein the auction format is a first-price sealed-bid auction.

4. A method for executing a concept auction, comprising:
inputting information for one or more concepts;
storing the concepts in a memory device;
assigning a number of shares to each concept;
assigning a bidding unit to each participant bidding on a selected concept; and
determining the results of the auction based on bid information provided by each participant.

5. The method of claim 4, including evaluating bid packages submitted by each participant.

6. The method of claim 5, wherein each bid package reflects a share price and total number of shares requested by each participant.

7. The method of claim 5, wherein evaluating the bid packages is executed by an arithmetic processor.

8. The method of claim 4, wherein determining the results of the auction include determining an opinion cluster.

9. The method of claim 4, wherein determining the results of the auction include determining a distribution of priority among all participants.

10. The method of claim 4, wherein determining the results of the auction include determining overall support for a particular concept in contrast to other concepts.

11. The method of claim 4, wherein determining the results of the auction include determining a ranking for each concept.

12. A computer-readable medium tangibly embodying a set of computer executable instructions, the instructions including instructions for:
receiving information relating to one or more concepts;
storing the concepts in a memory device;
assigning a number of shares to each concept;
assigning a bidding unit to each participant bidding on a selected concept; and
determining the results of the auction based on bid information provided by each participant.

13. The computer-readable medium of claim 12, further including instructions for creating a schedule and selecting concepts.

14. The computer-readable medium of claim 13, wherein selecting the concepts includes generating concepts of interest.

15. The computer-readable medium of claim 13, wherein selecting the concepts includes testing the concepts against comparability criteria.

16. The computer-readable medium of claim 12, further including instructions for creating an analysis report for each concept.

17. The computer-readable medium of claim 12, further including instructions for conducting a bidding process.

18. The computer-readable medium of claim 17, wherein conducting a bidding process includes calling bid participants, receiving the bids, and determining if the bids have errors.

19. The computer-readable medium of claim 12, further including instructions for a bid clearing process.

20. The computer-readable medium of claim 19, wherein the bid clearing process includes reading auction parameters.
